(19) United States
(12) Patent Application Publication
(10) Pub. No.: US 2012/0193975 A1
(43) Pub. Date: Aug. 2, 2012

(54) VEHICLE BRAKE APPARATUS

(75) Inventor: Nobuyuki ISHII, Wako-shi (JP)

(73) Assignee: HONDA MOTOR CO., LTD, Tokyo (JP)

(21) Appl. No.: 13/362,878

(22) Filed: Jan. 31, 2012

(30) Foreign Application Priority Data
Jan. 31, 2011 (JP) 2011-017715

(51) Int. Cl. B60T 13/58

(52) U.S. Cl. 303/14

(57) ABSTRACT

A vehicle brake apparatus causes the brake control ECU to shut down control of the slave cylinder and the master cut valve in a failure mode in which the slave cylinder becomes inoperative due to a failure in the power supply, thereby allowing a brake fluid pressure generated by a master cylinder through operation of the brake pedal to actuate the wheel cylinder. The brake control ECU shuts down control of the slave cylinder and the master cut valve when the first monitoring device detects a failure in the power supply and the second monitoring device detects an interruption of the communication between the brake control ECU and other vehicle control devices that are provided independently of the brake control ECU.

### CROSS REFERENCES TO RELATED APPLICATIONS

The present application claims priority under 35 U.S.C. §119 to Japanese Patent Application No. 2011-017715, filed Jan. 31, 2011, entitled “Vehicle Brake Apparatus”. The contents of this application are incorporated herein by reference in their entirety.

### BACKGROUND OF THE INVENTION

### Description of the Related Art

A known BBW type brake apparatus is disclosed in Japanese Unexamined Patent Application Publication No. 2005-343366, which, if a slave cylinder becomes inoperative due to a failure in a power supply, transmits a brake fluid pressure generated by a master cylinder through operation of a brake pedal directly to wheel cylinders to brake wheels, thereby providing a fail-safe function.

It can be detected by a drop in the power supply voltage applied to a brake control electronic control unit (ECU) that the slave cylinder becomes inoperative due to a failure in the power supply. If the power supply voltage applied to a brake control ECU temporarily drops or is interrupted, control of the brake apparatus is unnecessarily shut down and as a result the slave cylinder becomes inoperative, which causes braking by a brake fluid pressure from the slave cylinder to be switched to braking by a brake fluid pressure from the master cylinder, causing a change in braking force which may give a driver a sense of discomfort.

### SUMMARY OF THE INVENTION

### Background of the Disclosure

### Field of the Invention

The present disclosure relates to a so-called brake-by-wire (BBW) type brake apparatus that converts an amount of brake pedal operation by a driver into an electric signal and thereby activates a fluid pressure generating device which in turn generates a brake fluid pressure to actuate a wheel cylinder.

The present disclosure provides a vehicle brake apparatus that can prevent control of the brake apparatus from being unnecessarily shut down when a power supply temporarily fails.

A first aspect of the present disclosure provides a vehicle brake apparatus which includes a master cylinder that generates a brake fluid pressure through an operation of a brake pedal, a stroke simulator that generates a reaction force against the operation of the brake pedal, a wheel cylinder that brakes a wheel, a master cut valve that can cut off a fluid passage connecting the master cylinder and the wheel cylinder, a fluid pressure generating device that is provided between the master cut valve and the wheel cylinder and generates a brake fluid pressure in accordance with an operation amount of the brake pedal, and a control device that, when the brake pedal is operated, closes the master cut valve and actuates the fluid pressure generating device while the stroke simulator is activated, wherein the control device has a first monitoring device that monitors the status of a power supply and a second monitoring device that monitors the status of communication between the control device and other vehicle control devices that are provided independently of the control device, and the control device shuts down control of the master cut valve and the fluid pressure generating device when the first monitoring device detects a failure in the power supply and the second monitoring device detects an interruption of the communication.

A second aspect of the present disclosure provides the vehicle brake apparatus of a first aspect, wherein the control device shuts down control of the master cut valve and the fluid pressure generating device when the second monitoring device detects that an interruption of the communication continues for a predetermined period of time.

The first and second master cut valves 32, 33 according to an embodiment correspond to the master cut valve according to the present disclosure. The slave cylinder 42 according to an embodiment corresponds to the fluid pressure generating device according to the present disclosure. The brake control ECU 72 according to an embodiment corresponds to the control device according to the present disclosure. The VSA control ECU 73, the engine control ECU 74, and the drive motor control ECU 75 according to an embodiment correspond to other control devices according to the present disclosure.

According to the first aspect, in a normal operating mode, the master cut valve is closed to cut off the fluid passage between the master cylinder and the fluid pressure generating device, which causes the fluid pressure generating device to generate a brake fluid pressure according to an operation amount of the brake pedal operated by a driver, thereby actuating the wheel cylinder. At the same time, the stroke simulator is actuated to generate a reaction force against the operation of the brake pedal. In a failure mode in which the fluid pressure generating device becomes inoperative due to a failure in the power supply, a brake fluid pressure generated by a master cylinder through operation of the brake pedal actuates the wheel cylinder.

The control device shuts down control of the master cut valve and the fluid pressure generating device when the first monitoring device detects a failure in the power supply and the second monitoring device detects an interruption of the communication between the control device and other vehicle control devices that are provided independently of the control device, thereby securely preventing an unnecessary shutdown of the brake apparatus caused by a temporary failure in the power supply.

According to the second aspect, the control device shuts down control of the master cut valve and the fluid pressure generating device when the second monitoring device detects that an interruption of the communication continues for a predetermined period of time, thereby more securely preventing an unnecessary shutdown of the brake apparatus caused by a temporary failure in the power supply.

### BRIEF DESCRIPTION OF THE DRAWINGS

The advantages of the disclosure will become apparent in the following description taken in conjunction with the drawings, wherein:

FIG. 1 is a diagram of a fluid pressure circuit for a vehicle brake apparatus;

FIG. 2 is a diagram showing a control system configuration of a vehicle brake apparatus;

FIG. 3 is a diagram of a fluid pressure circuit for a vehicle brake apparatus in a normal braking mode.

FIG. 4 is a diagram of a fluid pressure circuit for a vehicle brake apparatus in a failure mode;

FIG. 5 is a block diagram of a control system of a slave cylinder;

FIG. 6 is an explanatory diagram for determination of a pedal stroke to target fluid pressure map; and

FIG. 7 is a flowchart for explaining a change to control modes for a brake apparatus.

### DESCRIPTION OF THE PREFERRED EMBODIMENTS

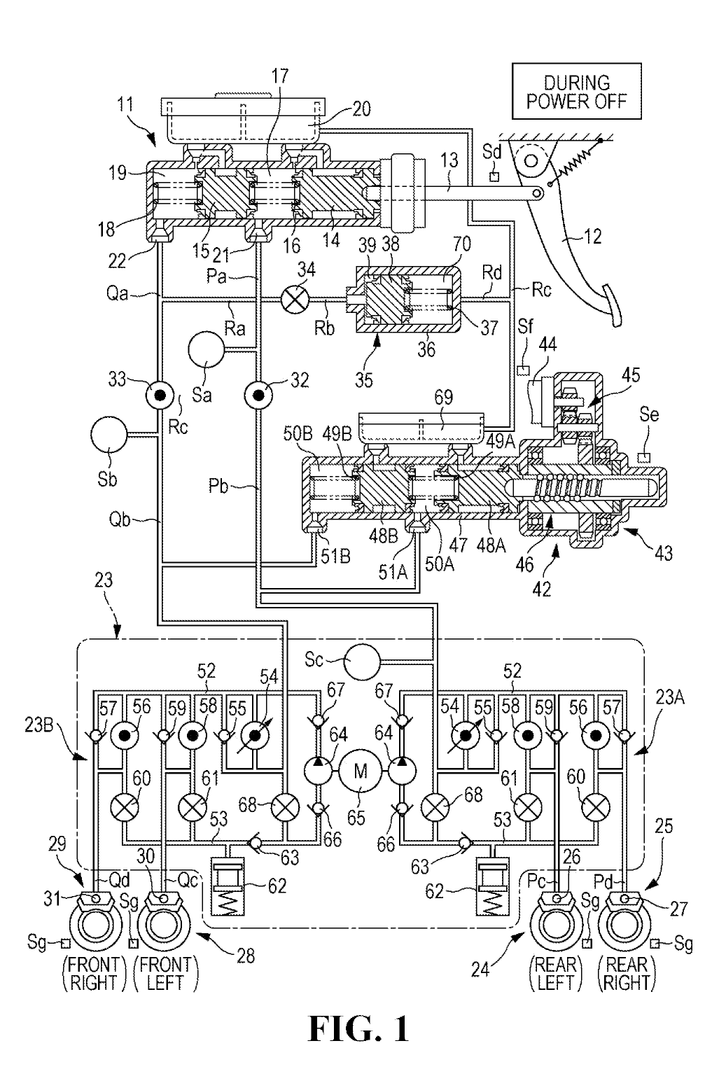

An embodiment of the present disclosure is described below with reference to FIGS. 1 through 7.

As shown in FIG. 1, a tandem type master cylinder 11 has a first piston 14 that is connected to a brake pedal 12 operated by a driver with a push rod 13 therebetween, a second piston 15 disposed ahead of the first piston 14, a first fluid pressure chamber 17 that is defined between the first piston 14 and the second piston 15 and has a return spring 16 housed therein, and a second fluid pressure chamber 19 that is defined ahead of the piston 15 and has a return spring 18 housed therein. The first fluid pressure chamber 17 and the second fluid pressure chamber 19 which can be communicated with a reservoir 20 have a first output port 21 and a second output port 22, respectively. The first output port 21 is connected to, for example, wheel cylinders 26, 27 (first system) in disc brake devices 24, 25 of left and right rear wheels via fluid passages Pa, Pb, a vehicle stability assist (VSA) device 23, and fluid passages Pc, Pd, while the second output port 22 is connected to, for example, wheel cylinders 30, 31 (second system) in disc brake devices 28, 29 of left and right front wheels via fluid passages Qa, Qb, the VSA device 23, and fluid passages Qc, Qd.

In this description, the upstream side of the fluid passages Pa to Pd and the fluid passages Qa to Qd refers to the side of the master cylinder 11, while the downstream side refers to the side of the wheel cylinders 26, 27; 30, 31.

A first master cut valve 32 that is a normally open electromagnetic valve is disposed between the fluid passages Pa, Pb, while a second master cut valve 33 that is a normally open electromagnetic valve is disposed between the fluid passages Qa, Qb. A supply fluid passages Ra, Rb that are branched from the fluid passage Qa at a point upstream of the second master cut valve 33 are connected to a stroke simulator 35 via a simulator valve 34 that is a normally closed electromagnetic valve. The stroke simulator 35 includes a cylinder 36 having a spring 37 biased piston 38 slidably fitted thereinto, in which a fluid pressure chamber 39 formed on the opposite side of the spring 37 is in communication with the supply fluid passage Rb.

A tandem type slave cylinder 42 is connected to the fluid passage Pb and the fluid passage Qb at points downstream of the master cut valves 32, 33. An actuator 43 for actuating the slave cylinder 42 transmits rotational power of a motor 44 to a ball screw mechanism 46 via a gear train 45. A cylinder 47 of the slave cylinder 42 has a first piston 48A driven by the ball screw mechanism 46 and a second piston 48B ahead of the first piston 48A slidably fitted thereinto. The cylinder 47 also has a first fluid pressure chamber 50A that is defined between the first piston 48A and the second piston 48B and has a return spring 49A housed therein and a second fluid pressure chamber 50B that is defined ahead of the second piston 48B and has a return spring 49B. When the ball screw mechanism 46 in the actuator 43 drives the first and second pistons 48A, 48B in a forward direction, a brake fluid pressure generated in the first and second fluid pressure chambers 50A, 50B is transmitted to the fluid passages Pb, Qb through first and second output ports 51A, 51B.

A reservoir 69 of the slave cylinder 42 and the reservoir 20 of the master cylinder 11 are connected to each other through a discharge fluid passage Rc. A back chamber 70 rearward of the piston 38 in the stroke simulator 35 is connected to the middle portion of the discharge fluid passage Rc through a discharge fluid passage Rd.

The VSA device 23 has a well-known structure which includes a first brake actuator 23A that controls a first system of the disc brake devices 24, 25 in left and right rear wheels and a second brake actuator 23B that controls a second system of the disc brake devices 28, 29 in left and right front wheels, both of which have the same structure.

The first brake actuator 23A that controls the first system of the disc brake devices 24, 25 in left and right rear wheels is typically described below.

The first brake actuator 23A is disposed between the fluid passage Pb connected to the upstream first master cut valve 32 and the fluid passages Pc, Pd that are connected respectively to the downstream wheel cylinders 26, 27 of the left and right rear wheels.

The first brake actuator 23A includes fluid passages 52, 53 that are common to the wheel cylinders 26, 27 of the left and right rear wheels, a regulator valve 54 of a normally open electromagnetic valve having variable openings which is disposed between the fluid passage Pb and the fluid passage 52, a check valve 55 that is arranged in parallel to the regulator valve 54 and permits the flow of a brake fluid from the fluid passage Pb to the fluid passage 52, an inlet valve 56 of a normally open electromagnetic valve disposed between the fluid passage 52 and the fluid passage Pd, a check valve 57 that is arranged in parallel to the inlet valve 56 and permits the flow of a brake fluid from the fluid passage Pd to the fluid passage 52, an inlet valve 58 of a normally open electromagnetic valve disposed between the fluid passage 52 and the fluid passage Pc, a check valve 59 that is arranged in parallel to the inlet valve 58 and permits the flow of a brake fluid from the fluid passage Pc to the fluid passage 52, an outlet valve 60 of a normally closed electromagnetic valve disposed between the fluid passage Pd and the fluid passage 53, an outlet valve 61 of a normally closed electromagnetic valve disposed between the fluid passage Pc and the fluid passage 53, a reservoir 62 connected to the fluid passage 53, a check valve 63 that is disposed between the fluid passage 53 and the fluid passage Pb and permits the flow of a brake fluid from the fluid passage 53 to the fluid passage Pb, a pump 64 that is disposed between the fluid passage 52 and the fluid passage 53 and delivers a brake fluid from the fluid passage 53 to the fluid passage 52, a motor 65 for driving the pump 64, a pair of check valves 66, 67 that are provided in inlet and outlet sides of the pump 64 and prevents backward flow of a brake fluid, and a suction valve 68 of a normally closed electromagnetic valve that is disposed between the middle of the check valve 63 and the pump 64 and the fluid passage Pb.

Although the motor 65 is shared by the pumps 64, 64 of the first and second brake actuators 23A, 23B, the two motors 65, 65, one for the first brake actuator 23A and the other for the second brake actuator 23B, may be used.

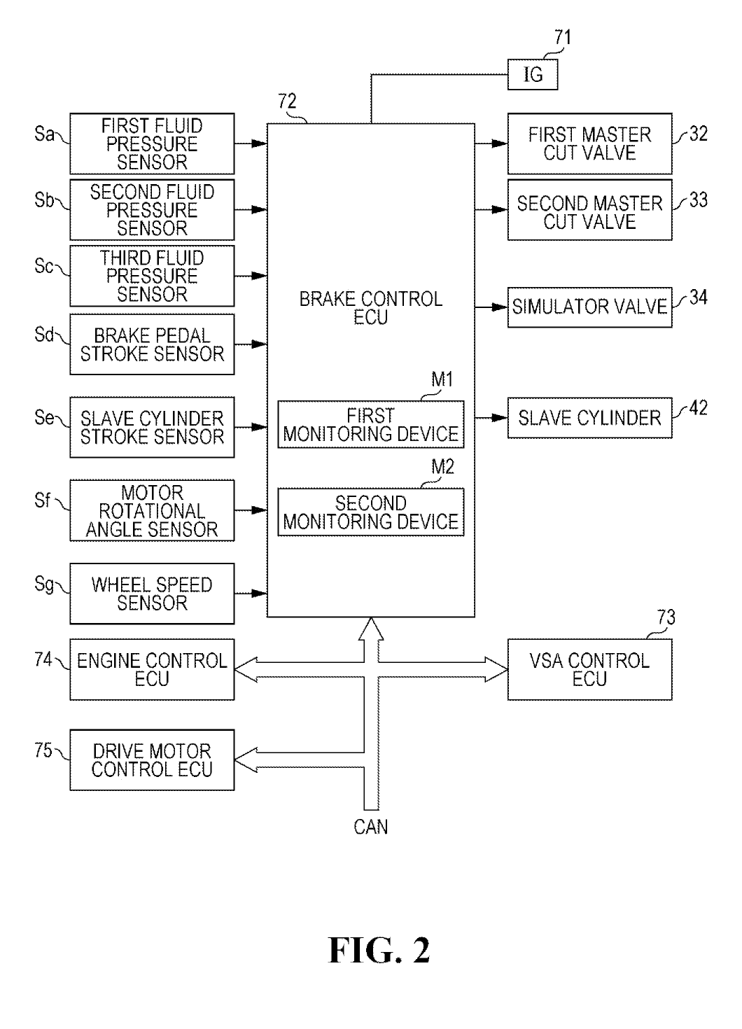

As shown in FIGS. 1 and 2, a first fluid pressure sensor Sa for detecting a fluid pressure is connected to the fluid passage Pa at a point upstream of the first master cut valve 32. Also, a second fluid pressure sensor Sb for detecting a fluid pressure is connected to the fluid passage Qb at a point downstream of the second master cut valve 33. Furthermore, a third fluid pressure sensor Sc for detecting a fluid pressure is connected to the fluid passage Pb at a point downstream of the first master cut valve 32. The third fluid pressure sensor Sc is a fluid pressure sensor that is provided in the VSA device 23 for control use.

The first fluid pressure sensor Sa, the second fluid pressure sensor Sb, the third fluid pressure sensor Sc, a brake pedal stroke sensor Sd for detecting a stroke of the brake pedal 12, a slave cylinder stroke sensor Se for detecting a stroke of the slave cylinder 42, a motor rotational angle sensor Sf for detecting a rotational angle of the motor 44, and a wheel speed sensor Sg for detecting wheel speeds are connected to a brake control ECU 72 to which the first and second master cut valves 32, 33, the simulator valve 34, the slave cylinder 42, and a power supply 71 such as a vehicle battery are connected.

In addition, a VSA control ECU 73, an engine control ECU 74, and the drive motor control ECU 75 that are other vehicle control devices are connected to the brake control ECU 72 via a controller area network (CAN). The VSA control ECU 73, the engine control ECU 74, and the drive motor control ECU 75 share the power supply 71 with the brake control ECU 72, but operates independently of the brake control ECU 72.

The brake control ECU 72 is provided with a first monitoring device M1 and a second monitoring device M2. The first monitoring device M1 monitors the status of the power supply 71, namely, the voltage of the power supply 71 applied to the brake control ECU 72, while the second monitoring device M2 monitors the status of communication between the brake control ECU 72 and the VSA control ECU 73 via the CAN, the status of communication between the brake control ECU 72 and the engine control ECU 74 via the CAN, or the status of communication between the brake control ECU 72 and the drive motor control ECU 75 via the CAN. On the basis of thus obtained monitoring results, the brake control ECU 72 makes a determination as to whether or not a brake apparatus has a power failure.

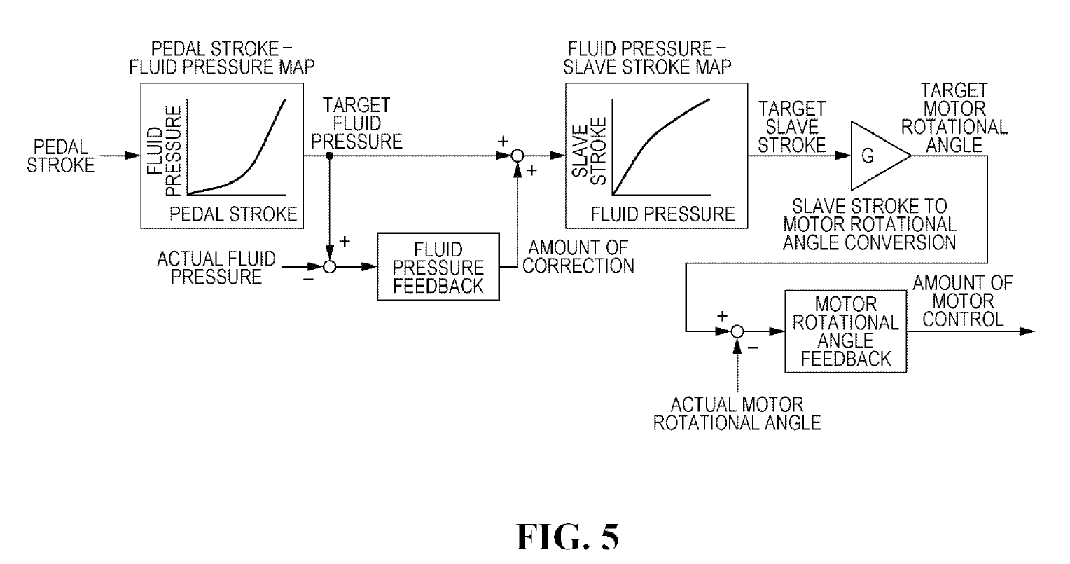

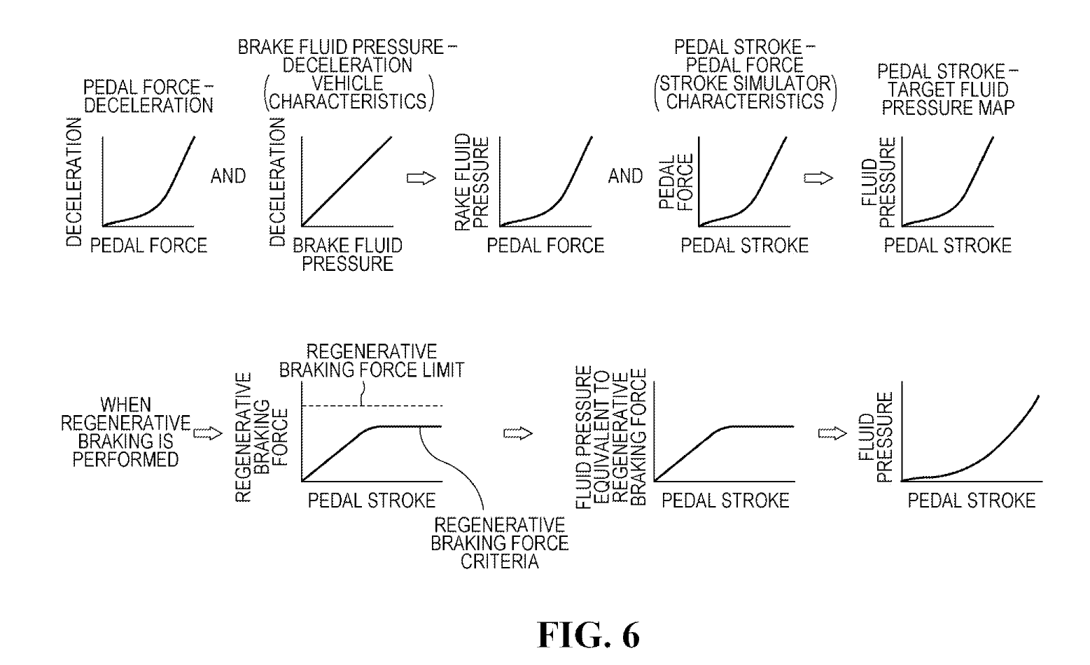

Control of the slave cylinder 42 is described below with reference to FIGS. 5 and 6.

As shown in FIG. 5, a stroke of the brake pedal 12 detected by the pedal stroke sensor Sd is converted through a pedal stroke to fluid pressure map into a target fluid pressure to be generated by the slave cylinder 42. The pedal stroke to fluid pressure map is determined in accordance with the steps described in FIG. 6.

A map showing the relationship between a pedal force of the brake pedal 12 and a brake fluid pressure to be generated by the slave cylinder 42 is calculated from a map showing the relationship between the pedal force of the brake pedal 12 and the deceleration to be generated by a vehicle and a map showing the relationship between the brake fluid pressure generated by the slave cylinder 42 and the deceleration of the vehicle. Next, from thus obtained map and a map showing the relationship between the stroke of the brake pedal 12 and the pedal force of the brake pedal 12, a map (pedal stroke to target fluid pressure map) showing the stroke of the brake pedal 12 and a target fluid pressure to be generated by the slave cylinder 42 is calculated.

For electric vehicles and hybrid vehicles provided with drive electric motors (not illustrated) which can provide regenerative braking, a value obtained by subtracting a fluid pressure equivalent to regenerative braking from the above-mentioned target fluid pressure is treated as a final target fluid pressure. Doing this allows determination of the target fluid pressure corresponding to the stroke of the brake pedal 12, taking regenerative braking (regenerative torque) into consideration. Regenerative braking force and a brake fluid pressure equivalent to the regenerative braking force can be determined by a known approach. For example, the regenerative braking force criteria corresponding to a pedal stroke is determined from the maps. A target regenerative braking force is set so as to correspond to a smaller one of the regenerative braking force criteria and a regenerative braking force limit that is dependent on ambient temperatures and the residual capacity of batteries. Then, a brake fluid pressure corresponding to the target regenerative braking force is determined from the maps. Thus obtained brake fluid pressure is subtracted from the above mentioned target fluid pressure, giving the final target fluid pressure.

Returning to FIG. 5, a deviation between the target fluid pressure to be generated by the slave cylinder 42, calculated from the pedal stroke to target fluid pressure map, and an actual fluid pressure generated by the slave cylinder 42, detected by the second fluid pressure sensor Sb, is calculated, and a fluid pressure correction amount determined from thus obtained deviation is added to the target fluid pressure, thereby making a correction. Next, the target fluid pressure subjected to the correction is applied to a map showing the relationship between the fluid pressure generated by the slave cylinder 42 and the stroke of the slave cylinder 42, thereby determining the target stroke of the slave cylinder 42. Next, a deviation between a target rotational angle of the motor 44, obtained by multiplying the target stroke of the slave cylinder 42 by a predetermined gain, and an actual rotational angle of the motor 44, detected by the motor rotational angle sensor Sf, is calculated. Driving the motor 44 with the amount of motor control calculated from thus obtained deviation causes the slave cylinder 42 to generate a brake fluid pressure corresponding to the stroke of the brake pedal 12 detected by the brake pedal stroke sensor Sd.

An embodiment of the present disclosure having the above arrangement is described below.

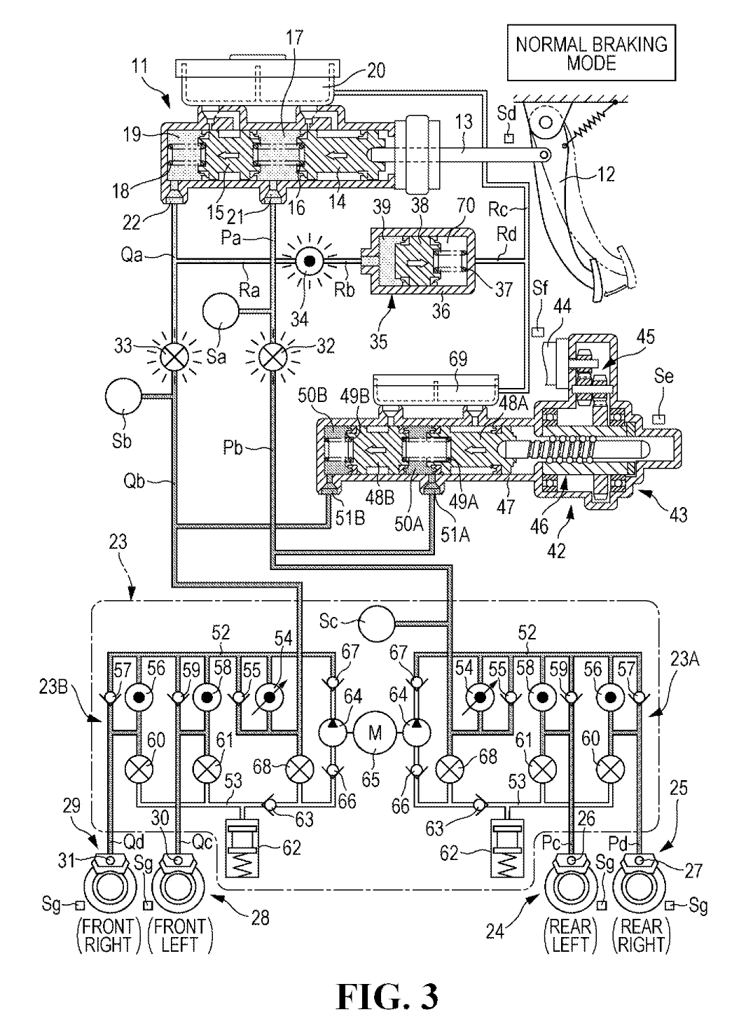

Normal braking operation during normal operation is described with reference to FIG. 3.

During normal system operation, if the first fluid pressure sensor Sa provided in the fluid passage Pa detects that a driver depresses the brake pedal 12, the first and second master cut valves 32, 33 of normally open electromagnetic valves are excited and closed, causing the simulator valve 34 of a normally closed electromagnetic valve to be excited and opened. At the same time, the actuator 43 of the slave cylinder 42 is actuated, which causes the first and second pistons 48A, 48B to move forward, thereby generating a brake fluid pressure in the first and second fluid pressure chambers 50A, 50B. Thus generated brake fluid pressure is transmitted through the first and second output ports 51A, 51B to the fluid passages Pb, Qb. Then, the brake fluid pressure is transmitted from the fluid passages Pb, Qb through the opened inlet valves 56, 56; 58, 58 of the VSA device 23 to the wheel cylinders 26, 27; 30, 31 of the disk brake devices 24, 25; 28, 29 to brake the wheels.

At this time, the simulator valve 34 of a normally closed electromagnetic valve is opened, which causes a fluid pressure generated in the second fluid pressure chamber 19 of the master cylinder 11 to be transmitted through the opened simulator valve 34 to the fluid pressure chamber 39 of the stroke simulator 35. Thus transmitted fluid pressure pushes the piston 38 against the force of the spring 37, thereby allowing stroking of the brake pedal 12 as well as generating a pseudo pedal reaction force and thereby eliminating a sense of discomfort that otherwise the driver feels.

Operation of the actuator 43 in the slave cylinder 42 is controlled in such a manner that a brake fluid pressure by the slave cylinder 42, detected by the second fluid pressure sensor Sb mounted in the fluid passage Qb, matches a brake fluid pressure by the master cylinder 11, detected by the first pressure sensor Sa mounted in the fluid passage Pa, thereby allowing the disk brake devices 24, 25; 28, 29 to generate a braking force according to an amount of brake pedal operation that the driver inputs to the brake pedal 12.

Next, operation of the VSA device 23 is described below.

When the VSA device 23 is deactivated, the regulator valves 54, 54 are demagnetized and opened, while the suction valves 68, 68 are demagnetized and closed. Also, the inlet valves 56, 56; 58, 58 are demagnetized and opened, while the outlet valves 60, 60; 61, 61 are demagnetized and closed. Accordingly, when the driver depresses the brake pedal 12 to actuate the slave cylinder 42 for braking, a brake fluid pressure output through the first and second output ports 51A, 51B of the slave cylinder 42 is delivered from the regulator valves 54, 54 through the opened inlet valves 56, 56; 58, 58 to the wheel cylinders 26, 27; 30, 31, thereby allowing the four wheels to be braked.

When the VSA device 23 is activated, the pumps 64, 64 are driven by the motor 65 with the suction valves 68, 68 excited and opened. As a result, a brake fluid is drawn from the side of the slave cylinder 42 through the suction valves 68, 68, pressurized through the pumps 64, 64, and delivered to the regulator valves 54, 54 and the inlet valves 56, 56; 58, 58. Accordingly, the brake fluid pressure in the fluid passages 52, 52 is regulated by exciting the regulator valves 54, 54 and regulating their openings. In addition, thus regulated fluid pressure is selectively delivered through the opened inlet valves 56, 56; 58, 58 to the wheel cylinders 26, 27; 30, 31, thereby allowing braking forces for the four wheels to be individually controlled even when the driver does not depress the brake pedal 12.

Consequently, the use of the first and second brake actuators 23A, 23B can individually control braking forces for the four wheels, thereby increasing the braking force of inner turning wheels for enhanced turning behavior or increasing the braking force of the outer turning wheels for enhanced straight line stability.

If it is detected on the basis of the output from the wheel speed sensor Sg that, for example, the rear left wheel tends to lock up on a low friction coefficient road when the driver is depressing the brake pedal 12 to brake the vehicle, one of the inlet valves 58 in the first brake actuator 23A is excited and closed, and at the same time one of the outlet valves 61 is excited and opened, thereby releasing the brake fluid pressure in the wheel cylinder 26 of the rear left wheel to the reservoir 62 to reduce the pressure to a predetermined level. After that, the outlet valve 61 is demagnetized and closed, thereby retaining the brake fluid pressure of the wheel cylinder 26 of the rear left wheel. As a result, when a wheel lock-up for the wheel cylinder 26 of the rear left wheel is resolved, the inlet valve 58 is demagnetized and opened, thereby delivering a brake fluid pressure through the first output port 51A of the slave cylinder 42 to the wheel cylinder 26 of the rear left wheel and increasing the pressure to a predetermined level to boost a braking force.

If the rear left wheel locks up again after the fluid pressure is increased, cycles of reducing, retaining, and increasing the fluid pressure are repeated, thereby performing antilock braking system (ABS) control under which a braking distance is minimized by suppressing the rear left wheel lock-up.

The ABS control associated with the wheel lock-up for the wheel cylinder 26 of the rear left wheel is described above. ABS control associated with a wheel lock-up for the wheel cylinder 27 of the rear right wheel, the wheel cylinder 30 of the front left wheel, and the wheel cylinder 31 of the front right wheel can be performed in the same manner.

If the power supply 71 fails, the slave cylinder 42 becomes inoperative, resulting in an inability to generate a brake fluid pressure. For this, a brake fluid pressure generated by the master cylinder 11 must be used to actuate the wheel cylinder 26, 27, 30, 31.

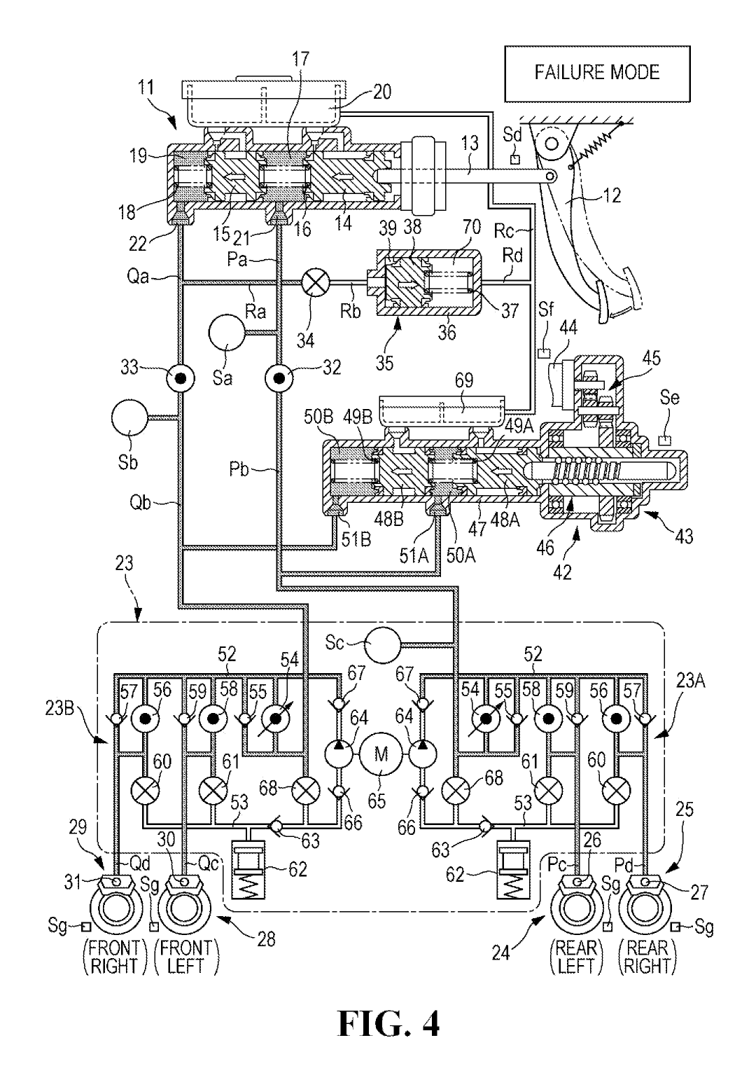

As shown in FIG. 4, if the power supply 71 fails, the first and second master cut valves 32, 33 of normally open electromagnetic valves are automatically opened and the simulator valve 34 of a normally closed electromagnetic valve is automatically closed, while the inlet valves 56, 56; 58, 58 and the regulator valves 54, 54 of normally open electromagnetic valves are automatically opened and the outlet valve 60, 60; 61, 61 and the suction valves 68, 68 of normally closed electromagnetic valves are automatically closed. With this arrangement, a brake fluid pressure generated in the first and second fluid pressure chambers 17, 19 of the master cylinder 11 does not go into the stroke simulator 35, but goes through the first and second master cut valves 32, 33 and the regulator valves 54, 54 and the inlet valves 56, 56; 58, 58 into the wheel cylinders 26, 27; 30, 31 in the disc brake devices 24, 25; 28, 29 of the wheels, where a braking force is generated without any difficulty.

As a measure against a failure in the slave cylinder 42, a member for preventing the first and second pistons 48A, 48B from moving rearward may be provided. Preferably, such a member has a structure that does not cause an increase in drive resistance during normal operation.

Just using the first monitoring device M1 for monitoring the voltage of the brake control ECU 72 is not enough to determine the presence of a failure in the power supply 71, because the vehicle brake apparatus normally operates without any difficulty when the power supply 71 experiences a temporal voltage drop or is temporarily interrupted for some reasons even if the ignition switch remains turned on. At this time, however, if the brake control ECU 72 suspends control of the slave cylinder 42 and the first and second master cut valves 32, 33, braking by a brake fluid pressure from the slave cylinder 42 is switched to braking by a brake fluid pressure from the master cylinder 11, which results in a change in braking force, causing a problem of giving the driver a sense of discomfort.

To solve this problem, this embodiment causes the first monitoring device M1 and the second monitoring device M2 to work together in a cooperative manner to make a determination as to the presence of a failure in the power supply 71 and shut down control of the vehicle apparatus only if the power supply 71 completely fails.

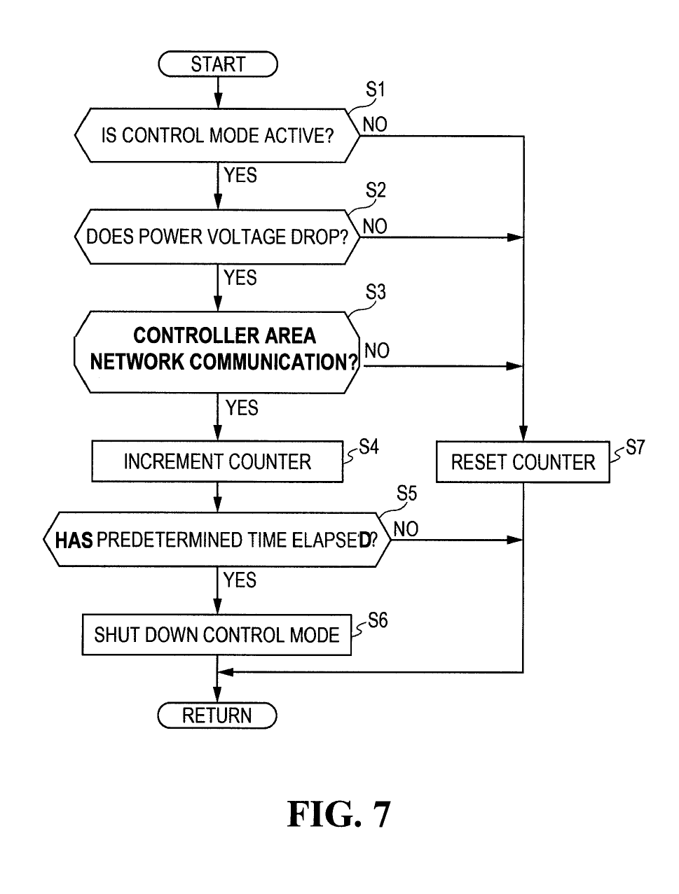

If, after the control mode of the brake apparatus is determined to be active in step S1 of the flowchart shown in FIG. 7, the first monitoring device M1 determines in step S2 that there is a drop (interruption) in the power supply voltage and the second monitoring device M2 makes a determination in step S3 as to communication with the VSA control ECU 73, the engine control ECU 74, or the drive motor control ECU 75 via the CAN, the counter is incremented in step S4. In contrast, if the determination is NO in step S1 or S2 or S3, the counter is reset in step S7.

If it is determined in step S5 that a predetermined time elapses after the counter is incremented in step S4, the control mode of the brake apparatus is switched from an active mode to a shutdown mode in step S6, causing the brake apparatus to be put into a failure mode shown in FIG. 4. Doing this allows a brake fluid pressure generated by the master cylinder 11 to actuate the wheel cylinders 26, 27; 30, 31 without any difficulty even if the slave cylinder 42 becomes inoperative due to a failure in the power supply 71.

As described above, if a failure in the power supply 71 and an interruption of the CAN communication continue for a predetermined period of time, the control mode of the brake apparatus is switched from an active mode to a shutdown mode, which can avoid an unnecessary shutdown of the brake apparatus control which results from a temporary drop in the voltage of the power supply 71 for some reasons and can also avoid a change in braking force which gives the driver a sense of discomfort.

When the control mode of the brake apparatus is a shutdown mode, the control mode is returned to a active mode on the condition that the first monitoring device M1 determines that the power supply voltage has been restored.

The present disclosure is typically described with reference to, but not limited to, the foregoing preferred embodiments. Various modifications are conceivable within the scope of the present disclosure.

For example, other vehicle control devices according to the present disclosure are not limited to the VSA control ECU 73, the engine control ECU 74, and the drive motor control ECU 75. Any vehicle control device may be used as long as it is independent of the brake control ECU.

The second monitoring device M2 is not limited to a monitoring device that monitors one-way communication from the VSA control ECU 73, the engine control ECU 74, or the drive motor control ECU 75 to the brake control device ECU 72. A monitoring device that monitors two-way communication between the brake control device ECU 72 and the VSA control ECU 73, the engine control ECU 74, or the drive motor control ECU 75 may be used.

The fluid pressure generating device according to the present disclosure is not limited to the slave cylinder 42 according to the embodiment. A known fluid pressure source that pressurizes the pressure of a high pressure source with a pump and regulates and delivers thus obtained pressure with an electromagnetic valve such as a linear valve to pressurize wheel cylinders may be used.

While embodiments of the present disclosure have been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A vehicle brake apparatus comprising:
a master cylinder that generates a brake fluid pressure through an operation of a brake pedal;
a stroke simulator that generates a reaction force against the operation of the brake pedal;
a wheel cylinder that brakes a wheel;
a master cut valve that can cut off a fluid passage connecting the master cylinder and the wheel cylinder;
a fluid pressure generating device that is provided between the master cut valve and the wheel cylinder and generates a brake fluid pressure in accordance with an operation amount of the brake pedal; and
a control device that, when the brake pedal is operated, closes the master cut valve and actuates the fluid pressure generating device while the stroke simulator is activated,
wherein the control device has a first monitoring device that monitors a status of a power supply and a second monitoring device that monitors communication between the control device and other vehicle control devices that are provided independently of the control device, and wherein the control device shuts down control of the master cut valve and the fluid pressure generating device when the first monitoring device detects a failure in the power supply and the second monitoring device detects an interruption of the communication between the control device and the other vehicle control devices.

2. The vehicle brake apparatus according to claim 1, wherein the control device shuts down control of the master cut valve and the fluid pressure generating device when the second monitoring device detects that an interruption of the communication continues for a predetermined period of time.
